(19) United States
(12) Patent Application Publication
(10) Pub. No.: US 2015/0135540 A1
(43) Pub. Date: May 21, 2015

(54) HYGIENIC TASTER

(71) Applicant: Jose Molano, JR., Ann Arbor, MI (US)

(72) Inventor: Jose Molano, JR., Ann Arbor, MI (US)

(21) Appl. No.: 13/261,948

(22) PCT Filed: Jul. 3, 2012
(86) PCT No.: PCT/PH2012/000009

§ 371 Date: Sep. 2, 2014

(30) Foreign Application Priority Data
Mar. 20, 2012 (PH) 1-2012-000059

(51) Int. Cl. A47J 43/28

(52) U.S. Cl. CPC A47J 43/281
USPC 30/141

(57) ABSTRACT

The invention is a device to enable repeated tasting of liquid food products and beverages as often as needed during preparation, without risk of human contamination of the food at the source. The essential characteristic of the invention is the fixing of an overhang spout (4) over the tasting cup (5), through which the liquid to be tasted falls freely into the tasting cup (5) with no possibility of backflow. The liquid sample is collected with a scoop (1) at one end of the device and is transferred by gravity with the flow controlled by the angle of tilt through a channel (2) miming along the handle to the spout (4) that lets the liquid fall into the tasting cup (5) from where it is sipped. The tasting operation or procedure can be repeated as often as needed without need to wash the device each time between tasting. Having no gates, levers or moving parts, it eliminates the risks of food contamination from leakages due to imperfections worn out parts, malfunction or poor operation.

### TECHNICAL FIELD

The invention applies to the field of food or beverage preparation, where the device is used for human tasting of the liquid food or beverage under preparation, while maintaining the sanitary condition at the source of the food or beverage being tasted.

### BACKGROUND ART

High standards of sanitation and cleanliness are normal requirements in the preparation of food or beverages at households or in commercial establishments such as restaurants, hotels, catering services, other food outlets and culinary schools. In many countries, strict health and sanitation regulations are enforced by authorities particularly in the operation of commercial food outlets, requiring the observance of certain methods or procedures to prevent human contamination of the food or beverage under preparation. Tasting the food or beverage is a procedure that usually takes place multiple times in the course of preparation, a procedure that also calls for stirring it in order to thoroughly blend the ingredients of the liquid before it is tasted.

Ordinary spoons or ladles once used for human tasting can not be dipped into the source again without contaminating the food, unless the utensil is first washed, or replaced altogether with a new spoon. Alternative procedures such as the transfer of the liquid to a second utensil or receptacle for tasting is not efficient. Devices such as those with a baffle or separator in the scoop or spoon may not effectively prevent contamination from human breath because of proximity between the segments of the scoop. Such baffled scoop is also inconvenient or difficult to use for stirring of the food before a subsequent tasting due to the risk that the tasting segment of the scoop could be accidentally dipped because the segments are only minutely separated from each other. Devices such as those with spoons or scoops at opposite ends of the handle and ordinarily connected to each other by a tube or channel for transfer of liquid by gravity, do not prevent the backflow of contaminated liquid from the tasting scoop to the other. Devices with two scoops equipped with a finger activated separating gate are not immune to natural or accidental leaks, and also call for the immediate dumping of the excess liquid in the tasting scoop. Devices with a mechanical gate also require a certain manual dexterity to operate in coordination with the flow of the liquid, have the disadvantage of possible leaks from imperfect or worn out parts, and need to have the mechanism unobstructed at all times from solid food particles that may come with the liquid.

### DISCLOSURE OF THE INVENTION

The invention is a device with a dipping scoop at one end, connected by a handle with a channel to a tasting cup at the other end, wherein the channel to the tasting cup protrudes as a spout over the upper middle section of the tasting cup. Liquid to be tasted is collected with the use of the scoop and transferred by gravity through the channel and to the spout, and falls freely into the tasting cup from which it can be sipped. The rate of flow of liquid through the channel is controlled by the user through its angle of tilt, though this is also regulated by the design of the channel which is narrow at the scoop end and wide at the tasting end. The volume of the tasting cup is made significantly larger than that of the scoop to prevent any spillage of liquid. The isolated overhang spout prevents any backflow of liquid from the cup to the channel or scoop or food under preparation, even with changes in position of the utensil. The hygienic taster can thus be used for stirring and tasting the food as many times as necessary in the course of preparation, without need to wash the utensil each time between each tasting. It is an improvement over the device with a baffle within the scoop, and the device with two scoops ordinarily connected by a channel or having a mechanical gate that closes the channel between the two scoops. The hygienic taster has no moving parts and does not require skills to operate, or any special cleaning or maintenance.

### BRIEF DESCRIPTION OF DRAWINGS

FIG. 1 shows the top view of the invention, while

FIG. 2 shows the side view with the scoop (1) which is used for stirring and collecting the liquid. The channel (2) which passes through the handle (3) is where the liquid runs through when transferred by gravity by tilting the device upward. The overhang spout (4) is where the liquid finally passes through to enable it to fall freely into the tasting cup (5). The broken line in FIG. 2 represents the inside surface of parts of the hygienic taster.

FIG. 3 is an isometric view of the scoop showing the narrow intake channel.

FIG. 4 is an isometric view showing the overhang spout which prevents the liquid collected in the tasting cup from flowing back to the opposite direction.

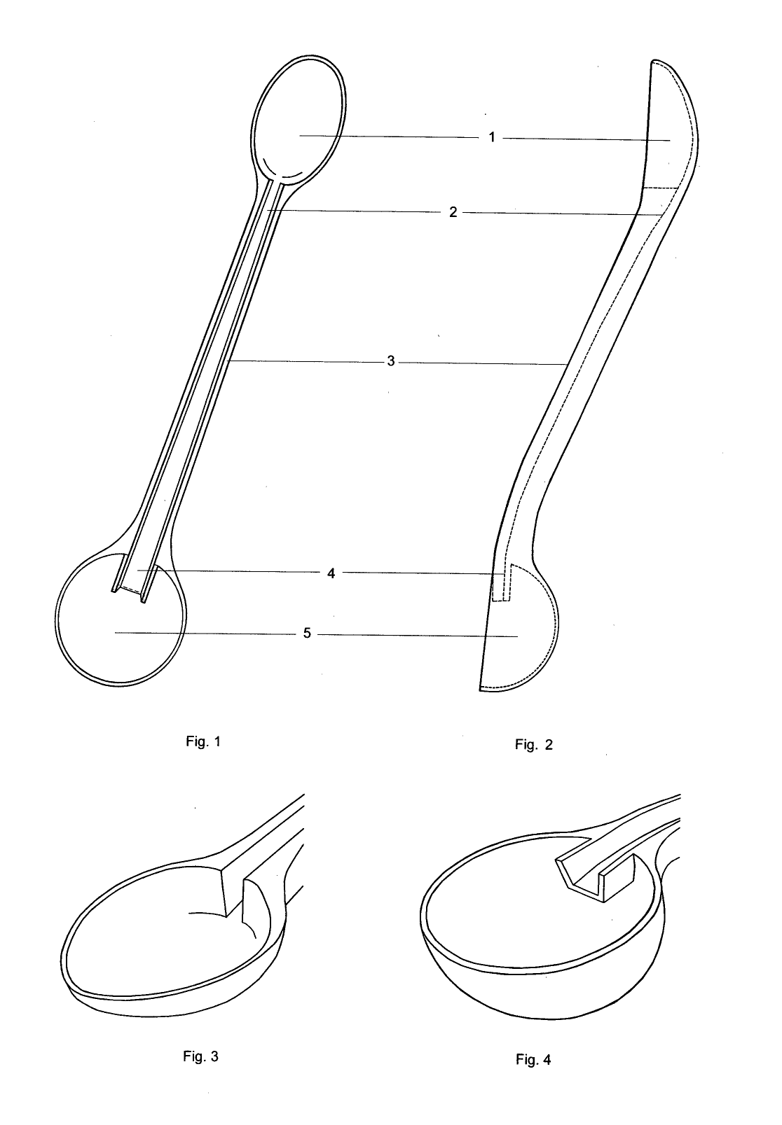

### BEST MODE FOR CARRYING OUT THE INVENTION

The invention will be best manufactured through an injection molding process of a non-toxic resin material that is heat resistant and dishwasher safe, such as melamine or other comparable resins.

### INDUSTRIAL APPLICABILITY

The invention would have a number of industrial applications such as use in establishments engaged in food and beverage preparations, namely: hotels, restaurants, catering services, fast food outlets, bars and pubs, culinary schools, breweries, wineries, the blending and packaging of juices, in addition to common household use.

The prior art in hygienic tasting devices consists of either a single scoop or spoon with a baffle separating one compartment for collecting the liquid and a second adjacent compartment for tasting; or two scoops connected by a handle containing a channel to allow liquid to be transferred from one scoop to the other, with a mechanical gate and a lever between the scoops to control the flow of liquid.

What is claimed for patent protection in this application are the following:

1. A device for the hygienic tasting of liquid food or beverages, characterized as having a collecting scoop at one end, connected to a tasting receptacle by a handle that houses a channel through its entire length and ending with an overhang spout fixed above the receptacle, so that liquid that is collected is transferred by gravity through the channel and made to fall freely from the overhang spout into the tasting receptacle at the other end of the device. What characterizes the invention against other devices is the fixing of an overhang spout which is located at a higher level than the inside of the cup and isolated from any contact with the fallen liquid, preventing liquid from flowing upward back to the channel or the scoop; with the tasting cup or receptacle containing a larger volume in relation to that of the scoop to ensure no overflow or spillage of the collected liquid.

2. Hygienic taster as in 1, characterized further as having a channel which is made narrow and deep at the scooping end, and gradually becoming wider toward the overhang spout which ends near the upper middle area of the tasting cup or receptacle, so that the widening channel serves to slow down the flow of the liquid to prevent spillage, and also allow cooling of hot liquids before tasting.

3. Hygienic taster as in 1, characterized further as having a scoop connected by a hollow handle or handle with an inside tube to a tasting cup or receptacle, where the hollow handle or inside tube protrudes as an overhang spout which ends near the upper middle area of the receptacle.

4. Hygienic taster as in 1 or 2 or 3, characterized as having either a handle that is straight, or a handle that is bent, with the scoop or the tasting cup or both fixed at a certain angle in relation to the handle.
